(19) United States
(12) Patent Application Publication
(10) Pub. No.: US 2001/0045299 A1
(43) Pub. Date: Nov. 29, 2001

(54) Lid or door structure and hinge structure

(75) Inventors: Sadaaki Miyamoto, Tokyo (JP); Yasuhiro Kitajima, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/867,233

(22) Filed: May 29, 2001

(30) Foreign Application Priority Data
May 29, 2000 (JP) 157702/2000

(51) Int. Cl. H02G 3/14

(52) U.S. Cl. 174/66

(57) ABSTRACT

A lid or door hinge structure is provided, which can reduce the number of components and eliminate the possibility of detachment from a body portion as a result of opening or closing motion and also is durable very much. In assembling, a protuberance 4 of a lid 2 is inserted in a recess 5 of a body portion 1. A recess 6 of the body portion 1 and a thorough hole 8 of the lid 2 are pivoted by each other by an L-shaped pin 7. The L-shaped pin 7 is then accommodated in an accommodation space 11 formed in the lid 2 by turning it about a pivotal axis.

### BACKGROUND OF THE INVENTION

This application claims benefit of Japanese Patent Application No. 2000-187702 filed on May 29, 2000, the contents of which are incorporated by the reference.

The present invention relates to a lid or door structure and hinge structures thereof.

FIG. 6 shows a prior art example of the hinge structure. This hinge structure comprises a pin constituting a pivotal axis, an E ring fitted on the pin, a spring exerting a pushing pressure to the E ring and a thorough hole formed in a body portion.

In this structure, to assemble the rotary parts to the body portion, the pin is pushed in direction A in the Figure to move a lid or door 22 (the pivotal axis of the pin) up to the thorough hole in the body portion 21. Then, the pin is fitted or engaged in the body portion with an opening motion of the E ring in direction B in the Figure. To disassemble the rotary parts, the pin is displaced by applying a pressure to it in direction A in the Figure, thus releasing the engagement of the pin in the thorough hole in the body portion and taking out the rotary parts.

FIG. 7 shows another prior art example of the hinge structure. This hinge structure comprises a special screw constituting a pivotal axis and an insert for securing the special screw. In this structure, to assemble a lid or door 22 as a rotary parts to the body portion 21 the axes of rotation of the rotary parts are aligned, and then the special screw is made up from the right side in the Figure and thus fitted in a thorough hole formed in the body portion.

FIG. 8 shows a further prior art example of the hinge structure. This hinge structure comprises a protuberance of an elastic member integral with rotary part constituting a pivotal axis and a thorough hole formed in a body portion. In this structure, to assemble the lid or door 22 as the rotary part the protuberance is caused to flex in direction A by making use of the elasticity of the rotary part itself, thus causing displacement of the pivotal axis of the protuberance and effecting the fitting thereof in the thorough hole in the body portion.

To release the protuberance from the engagement in the thorough hole in the body portion, the protuberance is likewise caused to flex in direction A by making use of the elasticity of the rotary part itself, thus releasing the engagement of the body through hole and the protuberance.

However, the above prior art detachable hinge structures have many components and are subject to restrictions on their assembling property and the mounting property of the hinged lid. Also, in the case that it is required to reduce the size and weight of not only the lid but also the body portion with the lid assembled thereto, stringent restrictions are imposed on the size of the components of the lid as a single part.

Even the prior art example shown in FIG. 8 which can solve these problems, has problems in the lid or door assembling property. Specifically, attaching importance to the lid or door assembling property by making the protuberance to be shorter and able to be more readily inserted in the thorough hole in the body portion, leads to increased possibility of detachment of such portion by an external force exerted to the lid or door when opening or closing the same. On the other hand, attaching importance to the detachment prevention by making the protuberance to be longer, leads to the assembling property problem that it is difficult to insert the protuberance through the thorough hole in the body portion. Although these problems may be solved by somewhat reducing the diameter of the protuberance, doing so may result in insufficient durability depending on the kind of the elastic member employed.

### SUMMARY OF THE INVENTION

The present invention was made in order to solve the above problems, and it seeks to provide a lid or door structure and a hinge structure thereof, which can reduce the number of component parts, permits readily assembling to the body portion, can prevent detachment from the body portion and is durable very much.

According to an aspect of the present invention, there is provided a lid or door structure in which the lid or door is pivotally assembled to a body portion such that the pivotal axis is a line connecting two recesses formed face to face in the body portion, comprising: a protuberance fitted in either one of the two recesses; a thorough hole formed in the lid or door at a position thereof close to the other recess; and a pin inserted in the recess of the body portion and the through hole of the lid or door to provide a pivot function.

The protuberance is integral with the lid or door and the pin is L-shaped.

According to another aspect of the present invention, there is provided a lid or door structure in which the lid or door is pivotally assembled to a body portion such that the pivotal axis is a line connecting two recesses formed face to face in the body portion, comprising: a protuberance fitted in either one of the two recesses; a thorough hole formed in the lid or door at a position thereof close to the other recess; a pin inserted in the recess of the body portion and the through hole of the lid or door to provide a pivot function; and an accommodation part for accommodating or holding the pin.

The accommodation part is channel- or U-shaped in profile and includes a pawl having elastic property.

According to other aspect of the present invention, there is provided a hinge structure of a lid with a pivotal axis thereof constituted by a line connecting two recesses formed face to face in a body portion, wherein: a protuberance as a portion of and integral with the lid is fitted in one of the two recesses; and a thorough hole formed in the lid is pivoted by a pivotal axis pin to the body portion at a position thereof close to the other recess.

With this structure, it is possible to reduce the number of components of the hinge part of the lid or door and also simplify the assembling procedure. Furthermore, since the lid has only a through hole provided at a position close to the recess in the body portion and does not have any raised portion, the protuberance can be readily fitted in the recess, and the lid can be readily assembled to and disassembled from the body portion. Further, it is possible to reduce the number of components of the hinge part of the lid.

Other objects and features will be clarified from the following description with reference to attached drawings.

### BRIEF DESCRIPTION OF THE DRAWINGS

FIG. 1 shows the whole body comprising a body portion and a lid;

FIG. 2 shows the body in a state after opening the lid provided on the body portion by turning the same;

FIG. 3 is a fragmentary exploded perspective view showing the lid;

FIG. 4 is a view showing a hinge structure of the lid circled by A in FIG. 3;

FIG. 5 is a view showing B-B cross sectional view of the hinge structure of the lid in FIG. 4;

FIG. 6 shows a prior art example of the hinge structure;

FIG. 7 shows another prior art example of the hinge structure; and

FIG. 8 shows a further prior art example of the hinge structure.

### PREFERRED EMBODIMENTS OF THE INVENTION

Preferred embodiments of the present invention will now be described with reference to the drawings.

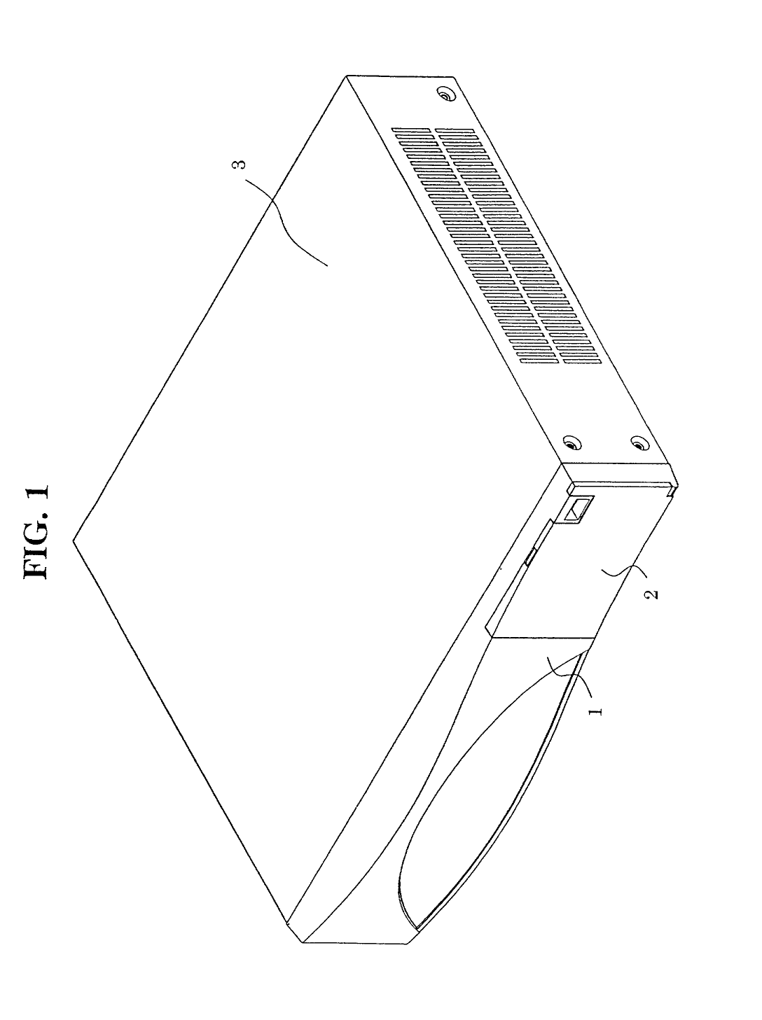

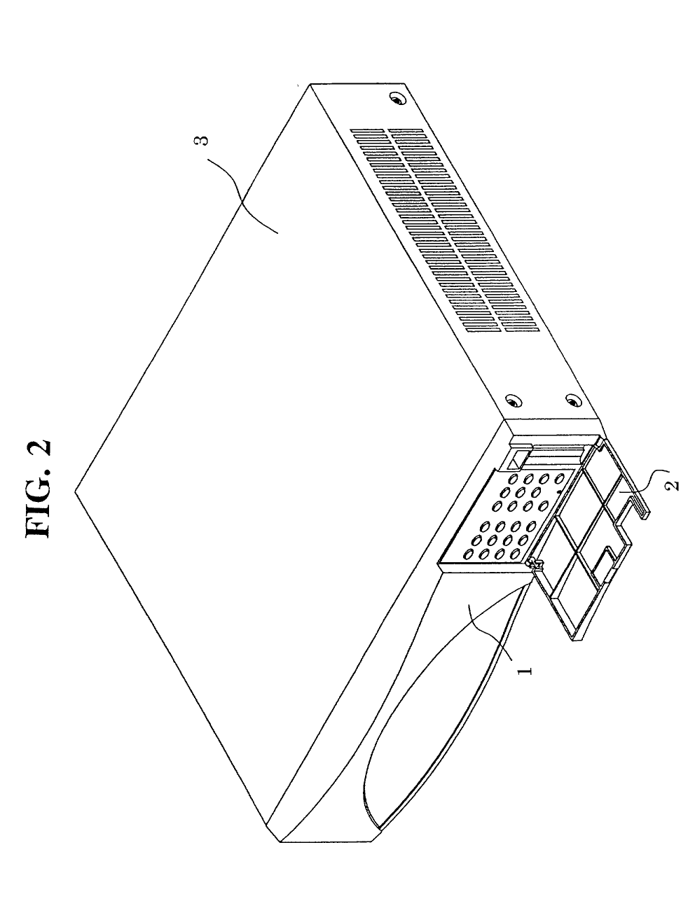

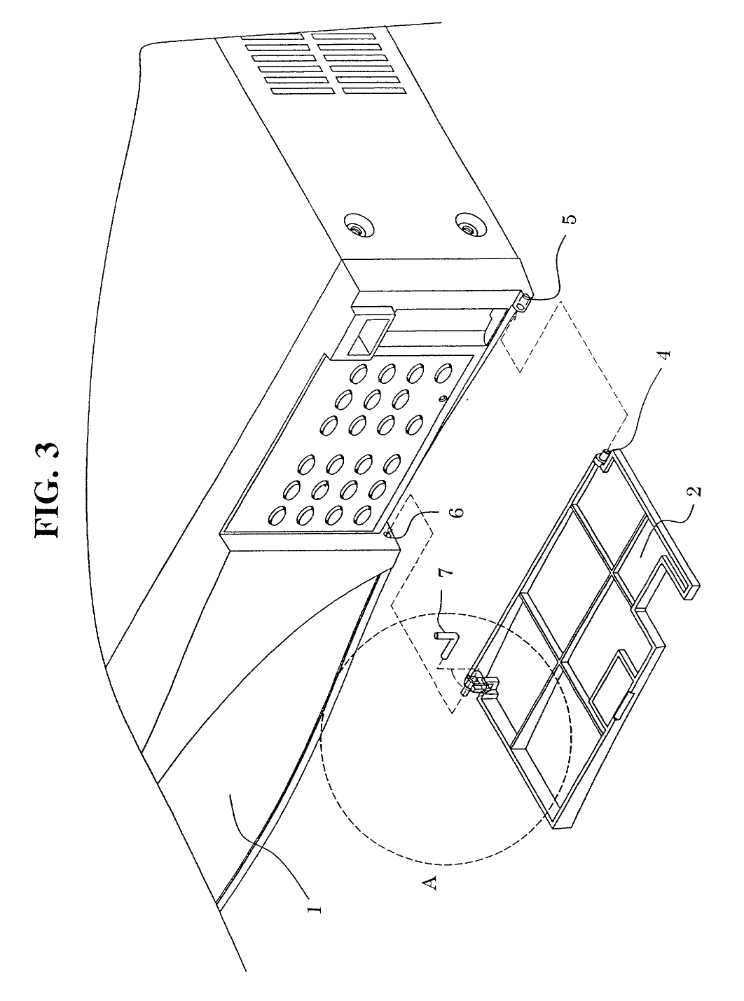

FIGS. 1 to 4 are views showing an embodiment of the present invention. FIG. 1 shows the whole body comprising a body portion and a lid. FIG. 2 shows the body in a state after opening the lid provided on the body portion by turning the same. FIG. 3 is a fragmentary exploded perspective view showing the lid. FIG. 4 is a view showing a hinge structure of the lid circled by A in FIG. 3.

Referring to FIG. 3, the body portion 1 has recesses 5 and 6. A lid or door 2 is pivotally assembled such that it is pivotal about a pivotal axis line connecting the recesses 5 and 6. The lid 2 has a protuberance 4 integral with it. The protuberance 4 is formed at an end of a side of the lid 2 corresponding to the pivotal axis thereof. The lid 2 also has a thorough hole 8. The hole 8 has substantially the same diameter as the recess 6, and is formed in the other end portion of the side noted above at a position close to the recess 6.

The protuberance 4 is fitted in the recess 5. The recess 6 and the thorough hole 8 are pivoted to each other by an L-shaped pin 7.

The lid 2, one side of which is not greater in length than the distance between the recesses 5 and 6, is assembled to the body portion 1 in the following way.

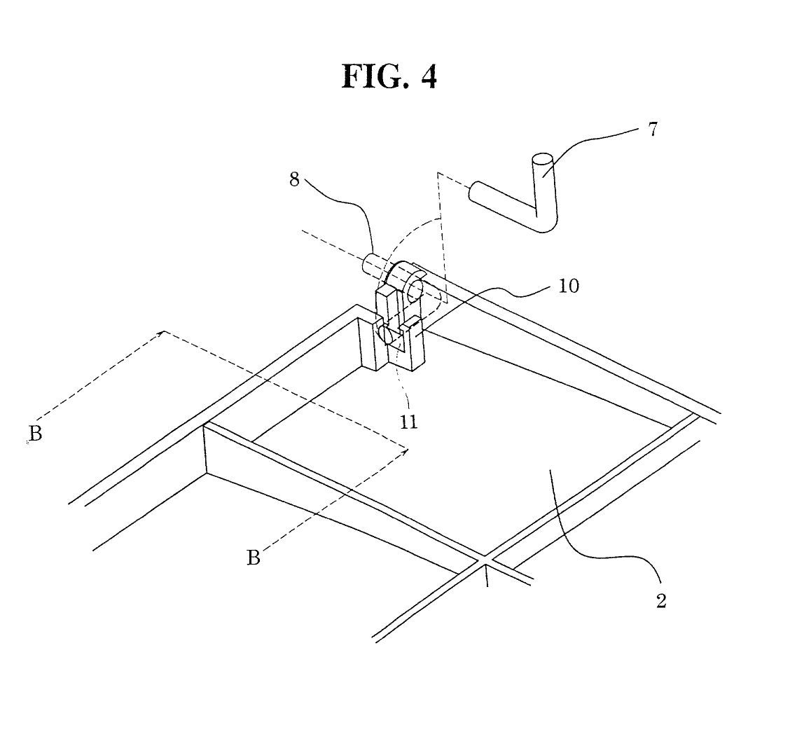

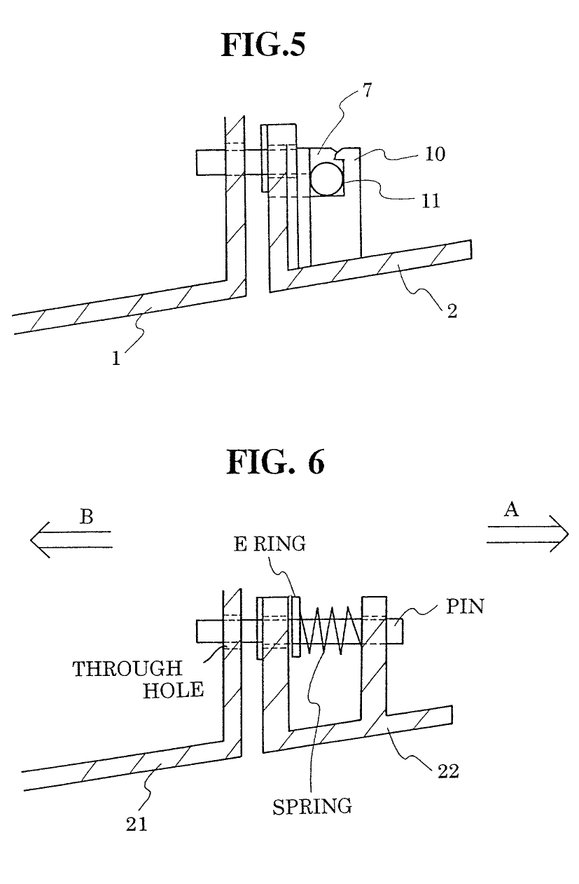

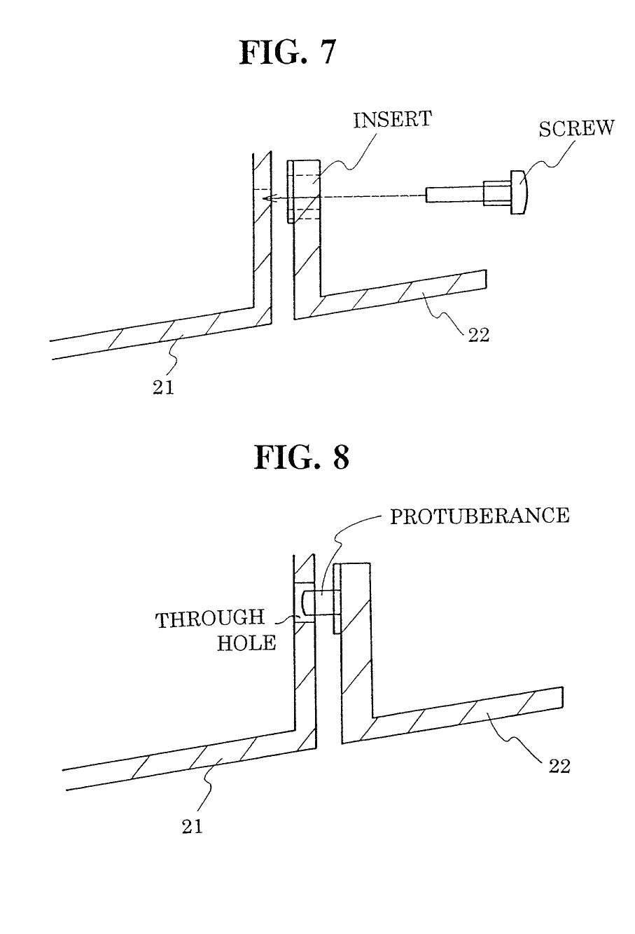

First, the protuberance 4 of the lid 2 is fitted in the recess 5 of the body portion 1. Then, the recess 6 and the thorough hole 8 are pivoted to each other with the L-shaped pin 7. At this time, the L-shaped pin 7 is rotated about the pivotal axis to be accommodated in an accommodation space 11 formed in the lid 2. As shown in FIG. 5, the accommodation space 11 is desirably channel- or U-shaped in profile. However, this shape is by no means limitative so long as the L-shaped pin 7 can be reliably accommodated and the L-shaped pin 7 can function as the pivotal axis.

To ensure reliable securing of the L-shaped pin 7, a pawl 10 is desirably provided in the accommodation space 11. The pawl 10 has an elastic property such that it causes the L-shaped pin 7 to be accommodated in the accommodation space 7 and secured to the lid 2. It is thus possible to have the L-shaped pin 7 to function as the pivotal axis.

To remove the lid 2 from the body portion 1, the L-shaped pin 7 is released from the accommodating space 11 by turning it about the pivotal axis. This can be done so owing to the elastic property of the pawl 10. Subsequently, the L-shaped pin 7 is withdrawn from the recess 6 of the body portion 1 and the thorough hole 8 of the lid 2. The lid 2 is then detached by withdrawing its protuberance 4 from the recess 5 of the body portion 1.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A lid or door structure in which the lid or door is pivotally assembled to a body portion such that the pivotal axis is a line connecting two recesses formed face to face in the body portion, comprising:
a protuberance fitted in either one of the two recesses;
a thorough hole formed in the lid or door at a position thereof close to the other recess; and
a pin inserted in the recess of the body portion and the through hole of the lid or door to provide a pivot function.

2. The lid or door structure according to claim 1, wherein the protuberance is integral with the lid or door.

3. The lid or door structure according to claim 1, wherein the p in is L-shaped.

4. A lid or door structure in which the lid or door is pivotally assembled to a body portion such that the pivotal axis is a line connecting two recesses formed face to face in the body portion, comprising:
a protuberance fitted in either one of the two recesses;
a thorough hole formed in the lid or door at a position thereof close to the other recess;
a pin inserted in the recess of the body portion and the through hole of the lid or door to provide a pivot function; and
an accommodation part for accommodating or holding the pin.

5. The lid or door structure according to claim 4, wherein the accommodation part is channel- or U-shaped in profile.

6. The lid or door structure according to claim 4, wherein the accommodation part includes a pawl having elastic property.

7. A hinge structure of a lid with a pivotal axis thereof constituted by a line connecting two recesses formed face to face in a body portion, wherein:
a protuberance as a portion of and integral with the lid is fitted in one of the two recesses; and
a thorough hole formed in the lid is pivoted by a pivotal axis pin to the body portion at a position thereof close to the other recess.
